(19) United States
(12) Patent Application Publication
(10) Pub. No.: US 2009/0066516 A1
(43) Pub. Date: Mar. 12, 2009

(54) Dual Mode RFID Tag Utilizing Dual Antennas

(75) Inventor: Phil LAZO, Mt. Airy, MD (US)

Correspondence Address: MOTOROLA, INC., 1303 EAST ALGONQUIN ROAD, IL01/3RD, SCHAUMBURG, IL, 60196, US

(73) Assignee: Symbol Technologies, Inc., Holtsville, NY (US)

(21) Appl. No.: 11/850,869

(22) Filed: Sep. 6, 2007

(51) Int. Cl. G08B 13/14

(52) U.S. Cl. 340/572.7; 340/572.4

(57) ABSTRACT

An RFID tags is constructed and arranged to have two or more antennas that are operable in two different frequency bands. An integrated circuit (IC) of the RFID tag is capable of configuring the RFID tag to operate as two distinct state machines, one corresponding to each of the frequency bands and antennas. A switch, responsive to manual control or an external signal causes the RFID tag to selectively operate in either of its modes and frequency bands.

### BACKGROUND

The inventions relate in general to the use of radio frequency identification (RFID) tags and RFID tag readers (also known as “interrogators”). In particular, the inventions relate to the configuration and operation of RFID tags in more than one frequency band and/or mode of operation.

Radio frequency identification (RFID) tags are electronic devices that may be affixed to items whose presence is to be detected and/or monitored. Various types of RFID tags operate in different frequency ranges and modes of operation and are therefore grouped in such a manner. The frequency ranges and modes of operation are standardized and the specifications for each are defined by national and international standards bodies (e.g., EPC Global and ISO). For example, standard tag classes include “Class 0”, “Class 1”, and “Class 1 Generation 2” (referred to as “Gen 2”).

The presence of an RFID tag, and therefore the presence of the item to which the tag is affixed, may be checked and monitored wirelessly by an “RFID reader”, also known as a “reader-interrogator”, “interrogator”, or simply “reader.” Readers may be designed to work with one particular class of RFID tag or they may be constructed and arranged so that they can be used with more than one class of RFID tag. A multi-class reader may have one or more antennas for transmitting radio frequency signals to RFID tags and receiving responses from them. An RFID tag within range of a reader-transmitted signal responds with a signal including a unique identifier associated with that tag and therefore with an item to which the tag is affixed.

A passive RFID tag is generally configured to operate in one of four (4) distinct frequency bands and operate according to a particular mode of operation. The operation of particular tag is controlled by its integrated circuit (IC) which is configured to provide control logic for the RFID tag. Generally, the IC is configured to operate at least in part as a “state machine” that operates the RFID tag from state to state according to a predetermined program or series of steps of operation. For example, these states may include states corresponding to the reception of an interrogation signal, applying back-scatter modulation, etc.

RFID tags and systems are utilized in many different industries and have a variety of applications. The frequency band in which a particular RFID tag operates tends to dictate its physical characteristics due to various design considerations including type of antenna required, performance characteristics and the system in which it is intended to operate. For example, a short range application of an RFID tag may be better suited for one particular frequency band and mode of operation than another. An application requiring operation over a longer range may be better suited for a different frequency range and mode of operation. Within a particular industry in which RFID systems are used, there may be applications that require that a particular feature set supported by one particular type of RFID system.

For example, a contactless payment application is supported by an RFID system that provides secure tag/reader communications, and that utilizes a short reading range. RFID tags that operate at Low Frequency (LF) in the 125 KHz band or High Frequency (HF) in the 13.56 MHz band support such applications well.

As another example, RFID systems that are used for electronic article surveillance in retail stores typically utilize magnetic induction technology. This may be either very low frequency (VLF) at 58 KHz or HF because it is necessary to overcome human body shielding and deep backfields that create false alarms due to tags being located too close to an exit door pedestal in the retail store.

Because of the many different types of modes in which various RFID systems operate, it would be useful to have RFID tags systems that are capable of operating in more than one frequency band and mode and be manually or automatically switchable among various modes of operation.

### SUMMARY

The purpose of this summary is to very generally describe some aspects of the invention, described more fully and by way of exemplary embodiments elsewhere in this patent document. It briefly introduces some preferred embodiments. Simplifications or omissions may be made to avoid obscuring the purpose of the section. Such simplifications or omissions are not intended to limit the scope of the claimed inventions. The inventions can be implemented in numerous ways, including methods, systems, devices, and computer readable medium. Several embodiments of the inventions are discussed below, but they are not the only ways to practice the inventions described herein.

The invention described herein relates to RFID tags and systems and parts of such systems that are capable of operating in more than one frequency band and in more than one mode. As used herein “mode” does not refer merely to different frequencies or bands of frequencies, even though operation at different frequencies alone may constitute operation in different modes. The concept of “mode” as used herein is broader and includes the concept of operations at more than one frequency or in selectable bands of frequencies, such as UHF and HF, but also contemplates other operational and physical parameters such as the air interface protocol between the reader and tag. The inventions described herein relate to dual and multi-mode RFID systems and RFID tags used in those systems. Such systems include an RFID reader that operates in more than one mode and RFID tags that also operate in more than one mode. Markets/applications where multi-mode systems are particularly useful include those that require a wider range of performance characteristics than are normally obtainable using one operating frequency or communications protocol.

Multi-mode systems are considered to be particularly useful in markets that are transitioning from one technology to another. For example, there is a rich set of applications, used by various governmental organizations, that require long range RFID reading, such as, for example, border crossing applications, and short range secure transactions, such as, for example, passport control. Such applications would be well served by a single RFID system that operates in dual modes with a dual mode RFID tag arrangement that users can carry across border checkpoints and passport control areas.

The retail industry is in technology transition. Retail loss prevention RFID applications are dominated by use of single bit tags powered by magnetic induction. However, the industry is transitioning to EPC tags that serve the needs of supply chain monitoring while also supporting loss prevention monitoring at retail store exits.

The inventions described herein can be implemented in numerous ways, including methods, systems, devices, and computer readable medium. Several embodiments of the inventions are discussed below, but they are not the only ways to practice the inventions described herein.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates an environment in which RFID tag readers communicate with a population of RFID tags.

FIG. 2 is a block diagram of an example RFID reader.

FIG. 3 is a schematic block diagram of an exemplary radio frequency identification (RFID) tag.

FIG. 3a is a schematic block diagram explaining the state machine feature of the invention.

FIG. 4 is a schematic diagram of an RFID tag having first and second integrated dipole antennas and an RFID integrated circuit (IC) having separate ports to which the first and second antennas are coupled.

FIG. 5 is a schematic diagram of an RFID reader interacting with an RFID tag having dual integrated antennas.

FIG. 6 is a schematic diagram of an RFID tag having first and second integrated antennas and an RFID integrated circuit (IC) having separate ports to which the first and second antennas are coupled.

FIG. 7 is a schematic diagram of an RFID system arrangement for a toll both type of application.

FIG. 8 is a schematic diagram of a dual mode RFID tag including a dipole antenna operating in the UHF band and a spiral antenna operating on the ISO 14443 standard.

### DETAILED DESCRIPTION

### Exemplary Operating Environment

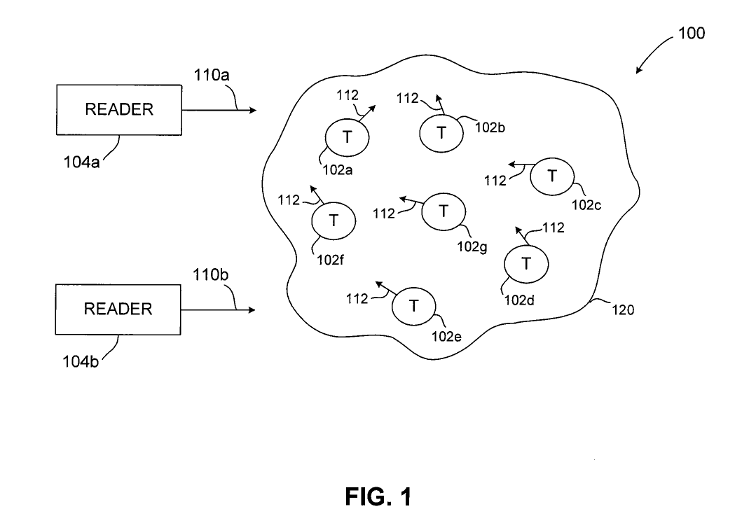

Before describing embodiments of the invention in detail, it may be helpful to understand an example RFID communications environment in which the inventions may be implemented. FIG. 1 illustrates an environment 100 where RFID tag readers 104 (readers 104a and 104b shown in FIG. 1) communicate with an exemplary population 120 of RFID tags 102. As shown in FIG. 1, the population 120 of tags includes seven tags 102a-102g. A population 120 may include any number of tags 102.

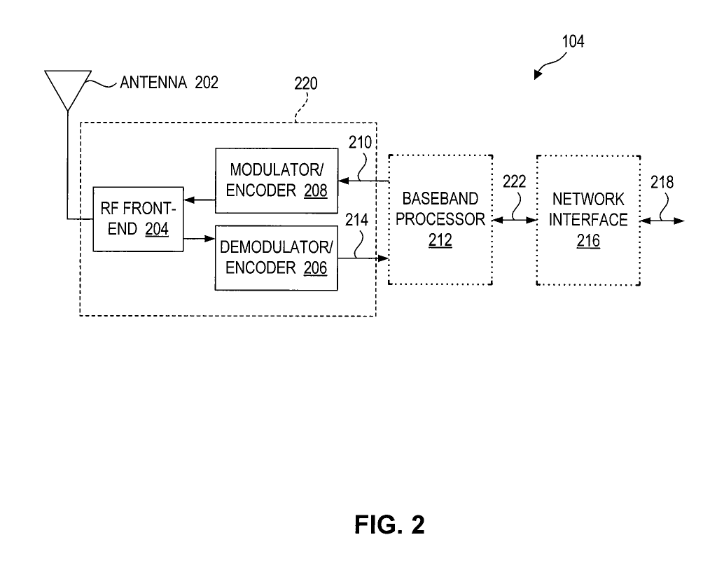

Environment 100 includes any number of one or more readers 104. For example, environment 100 includes a first reader 104a and a second reader 104b. Readers 104a and/or 104b may be requested by an external application to address the population of tags 120. Alternatively, reader 104a and/or reader 104b may have internal logic that initiates communication, or may have a trigger mechanism that an operator of a reader 104 uses to initiate communication. Readers 104a and 104b may also communicate with each other in a reader network (see FIG. 2). A reader 104 may be continuously commercial powered by attachment to power mains or it may be battery powered. The inventions described herein are particularly applicable to batter powered readers.

As shown in FIG. 1, reader 104a “reads” tags 120 by transmitting an interrogation signal 110a to the population of tags 120. Interrogation signals may have primary signal at a particular carrier frequency or may comprise a plurality of signals transmitted in a frequency hopping arrangement or some other configuration. Readers 104a and 104b typically operate in one or more of the frequency bands allotted for this type of RF communication. For example, the Federal Communication Commission (FCC) defined frequency bands of 902-928 MHz and 2400-2483.5 MHz for certain RFID applications.

Tag population 120 may include tags 102 of various types, such as, for example, various classes of tags as enumerated above. Thus, in response to interrogation signals, the various tags 102 may transmit one or more response signals 112 to an interrogating reader 104. Tags of one type, for example, respond by alternatively reflecting and absorbing portions of signal 104 according to a time-based pattern. This technique for alternatively absorbing and reflecting signal 104 is referred to as “backscatter modulation.” Backscatter modulation may include one or more alpha-numeric characters that uniquely identify a particular tag (and therefore an object to which the tag may be affixed). Readers 104a and 104b receive data from response signals 112, such as an identification number of the responding tag 102. In embodiments described herein, a reader may be capable of communicating with tags 102 according to various suitable communication protocols, including Class 0, Class 1, EPC Gen 2, other binary traversal protocols and slotted aloha protocols, and any other protocols mentioned elsewhere herein. They may be adapted to support communication protocols to be created in the future. Tag population 120 may include one or more tags having a packed object format described herein and/or one or more tags not using the packed object format, such as, for example, standard ISO tags.

FIG. 2 is a block diagram of an example RFID reader 104. Reader 104 includes one or more antennas 202, a receiver and transmitter portion 220 (also referred to as transceiver 220), a baseband processor 212, and a network interface 216. These components of reader 104 may include software, hardware, and/or firmware, or any combination thereof, for performing their functions. If RFID reader 104 is battery powered, it will also contain a battery.

Baseband processor 212 and network interface 216 are optionally present in reader 104. Baseband processor 212 may be present in reader 104, or may be located remote from reader 104. For example, in an embodiment, network interface 216 may be present in reader 104, to communicate between transceiver portion 220 and a remote server that includes baseband processor 212. When baseband processor 212 is present in reader 104, network interface 216 may be optionally present to communicate between baseband processor 212 and a remote server. In another embodiment, network interface 216 is not present in reader 104.

In an embodiment, reader 104 includes network interface 216 to interface reader 104 with a communications network 218. Baseband processor 212 and network interface 216 communicate with each other via a communication link 222. Network interface 216 is used to provide an interrogation request 210 to transceiver portion 220 (optionally through baseband processor 212), which may be received from a remote server coupled to communications network 218. Baseband processor 212 optionally processes the data of interrogation request 210 prior to being sent to transceiver portion 220. Transceiver 220 transmits the interrogation request via antenna 202.

Reader 104 has at least one antenna 202 for communicating with tags 102 and/or other readers 104. Antenna(s) 202 may be any type of reader antenna known to persons skilled in the relevant art(s), including for example and without limitation, a vertical, dipole, loop, Yagi-Uda, slot, and patch antenna type.

Transceiver 220 receives a tag response via antenna 202. Transceiver 220 outputs a decoded data signal 214 generated from the tag response. Network interface 216 is used to transmit decoded data signal 214 received from transceiver portion 220 (optionally through baseband processor 212) to a remote server coupled to communications network 218. Baseband processor 212 optionally processes the data of decoded data signal 214 prior to being sent over communications network 218.

In embodiments, network interface 216 enables a wired and/or wireless connection with communications network 218. For example, network interface 216 may enable a wireless local area network (WLAN) link (including a IEEE 802.11 WLAN standard link), a Bluetooth link, and/or other types of wireless communication links. Communications network 218 may be a local area network (LAN), a wide area network (WAN) (e.g., the Internet), and/or a personal area network (PAN).

In embodiments, a variety of mechanisms may be used to initiate an interrogation request by reader 104. For example, an interrogation request may be initiated by a remote computer system/server that communicates with reader 104 over communications network 218. Alternatively, reader 104 may include a finger-trigger mechanism, a keyboard, a graphical user interface (GUI), and/or a voice activated mechanism with which a user of reader 104 may interact to initiate an interrogation by reader 104.

In the example of FIG. 2, transceiver portion 220 includes a RF front-end 204, a demodulator/decoder 206, and a modulator/encoder 208. These components of transceiver 220 may include software, hardware, and/or firmware, or any combination thereof, for performing their functions. Example description of these components is provided as follows.

Modulator/encoder 208 receives interrogation request 210, and is coupled to an input of RF front-end 204. Modulator/encoder 208 encodes interrogation request 210 into a signal format, such as, for example, one of pulse-interval encoding (PIE), FM0, or Miller encoding formats, modulates the encoded signal, and outputs the modulated encoded interrogation signal to RF front-end 204.

RF front-end 204 may include one or more antenna matching elements, amplifiers, filters, an echo-cancellation unit, a down-converter, and/or an up-converter. RF front-end 204 receives a modulated encoded interrogation signal from modulator/encoder 208, up-converts (if necessary) the interrogation signal, and transmits the interrogation signal to antenna 202 to be radiated. Furthermore, RF front-end 204 receives a tag response signal through antenna 202 and down-converts (if necessary) the response signal to a frequency range amenable to further signal processing.

Demodulator/decoder 206 is coupled to an output of RF front-end 204, receiving a modulated tag response signal from RF front-end 204. In an EPC Gen 2 protocol environment, for example, the received modulated tag response signal may have been modulated according to amplitude shift keying (ASK) or phase shift keying (PSK) modulation techniques. Demodulator/decoder 206 demodulates the tag response signal. For example, the tag response signal may include backscattered data formatted according to FM0 or Miller encoding formats in an EPC Gen 2 embodiment. Demodulator/decoder 206 outputs decoded data signal 214.

The configuration of transceiver 220 shown in FIG. 2 is provided for purposes of illustration, and is not intended to be limiting. Transceiver 220 may be configured in numerous ways to modulate, transmit, receive, and demodulate RFID communication signals, as would be known to persons skilled in the relevant art(s).

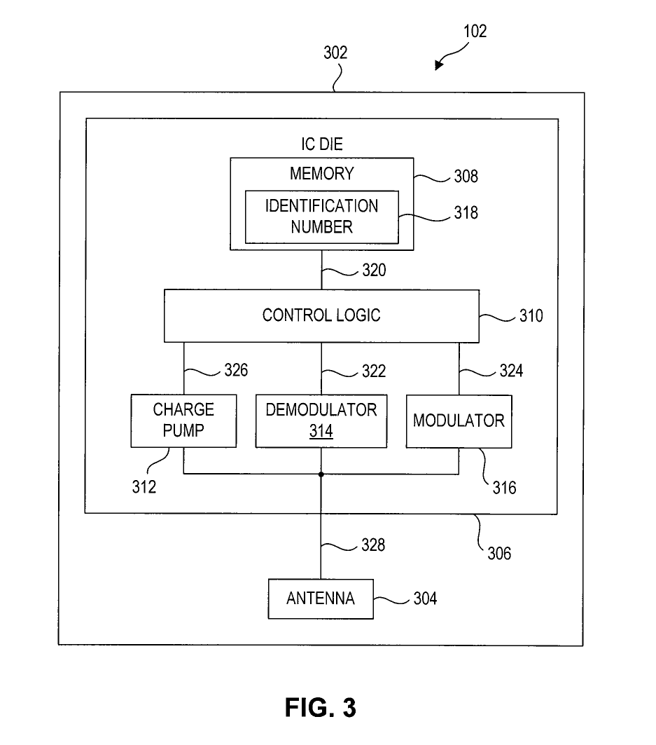

The invention described herein is applicable to various types of RFID tags and RFID reader systems. FIG. 3 is a schematic block diagram of an example radio frequency identification (RFID) tag 102. Tag 102 includes a substrate 302, an antenna 304, and an integrated circuit (IC) 306. Antenna 304 is formed on a surface of substrate 302. Antenna 304 may include any number of one, two, or more separate antennas of any suitable antenna type, including for example dipole, loop, slot, and patch. IC 306 includes one or more integrated circuit chips/dies, and can include other electronic circuitry. IC 306 is attached to substrate 302, and is coupled to antenna 304. IC 306 may be attached to substrate 302 in a recessed and/or non-recessed location.

IC 306 controls operation of tag 102, and transmits signals to, and receives signals from RFID readers using antenna 304. In the example of FIG. 3, IC 306 includes a memory 308, a control logic 310, a charge pump 312, a demodulator 314, and a modulator 316. Inputs of charge pump 312, and demodulator 314, and an output of modulator 316 are coupled to antenna 304 by antenna signal 328.

Demodulator 314 demodulates a radio frequency communication signal (e.g., interrogation signal 110) on antenna signal 328 received from a reader by antenna 304. Control logic 310 receives demodulated data of the radio frequency communication signal from demodulator 314 on an input signal 322. Control logic 310 controls the operation of RFID tag 102, based on internal logic, the information received from demodulator 314, and the contents of memory 308. For example, control logic 310 accesses memory 308 via a bus 320 to determine whether tag 102 is to transmit a logical “1” or a logical “0” (of identification number 318) in response to a reader interrogation. Control logic 310 outputs data to be transmitted to a reader (e.g., response signal 112) onto an output signal 324. Control logic 310 may include software, firmware, and/or hardware, or any combination thereof. For example, control logic 310 may include digital circuitry, such as logic gates, and may be configured as a state machine in an embodiment.

Modulator 316 is coupled to antenna 304 by antenna signal 328, and receives output signal 324 from control logic 310. Modulator 316 modulates data of output signal 324 (e.g., one or more bits of identification number 318) onto a radio frequency signal (e.g., a carrier signal transmitted by reader 104) received via antenna 304. The modulated radio frequency signal is response signal 112 (see FIG. 1), which is received by reader 104. In one example embodiment, modulator 316 includes a switch, such as a single pole, single throw (SPST) switch. The switch is configured in such a manner as to change the return loss of antenna 304. The return loss may be changed in any of a variety of ways. For example, the RF voltage at antenna 304 when the switch is in an “on” state may be set lower than the RF voltage at antenna 304 when the switch is in an “off” state by a predetermined percentage (e.g., 30 percent). This may be accomplished by any of a variety of methods known to persons skilled in the relevant art(s).

Charge pump 312 (or other type of power generation module) is coupled to antenna 304 by antenna signal 328. Charge pump 312 receives a radio frequency communication signal (e.g., a carrier signal transmitted by reader 104) from antenna 304, and generates a direct current (DC) voltage level that is output on tag power signal 326. Tag power signal 326 powers circuits of IC die 306, including control logic 320.

Charge pump 312 rectifies a portion of the power of the radio frequency communication signal of antenna signal 328 to create a voltage power. Charge pump 312 increases the voltage level of the rectified power to a level sufficient to power circuits of IC die 306. Charge pump 312 may also include a regulator to stabilize the voltage of tag power signal 326. Charge pump 312 may be configured in any suitable way known to persons skilled in the relevant art(s). For description of an example charge pump applicable to tag 102, refer to U.S. Pat. No. 6,734,797, titled “Identification tag Utilizing Charge Pumps for Voltage Supply Generation and Data Recovery,” which is incorporated by reference herein in its entirety. Alternative circuits for generating power in a tag, as would be known to persons skilled in the relevant art(s), may be present. Further description of charge pump 312 is provided below.

It will be recognized by persons skilled in the relevant art(s) that tag 102 may include any number of modulators, demodulators, charge pumps, and antennas. Tag 102 may additionally include further elements, including an impedance matching network and/or other circuitry. Furthermore, although tag 102 is shown in FIG. 3 as a passive tag, tag 102 may alternatively be an active tag (e.g., powered by battery).

Memory 308 is typically a non-volatile memory, but can alternatively be a volatile memory, such as a DRAM. Memory 308 stores data, including an identification number 318. In a Gen-2 tag, tag memory 308 may be logically separated into four memory banks.

### Dual Mode RFID Tag Embodiments

The invention described herein is directed to multi-mode RFID systems. Such systems can employ RFID tags that have more than one integrated antenna and utilize an integrated circuit (IC) having more than one antenna port so that each antenna can be separately coupled to the IC. For example, the RFID tag may have an integrated dual dipole antenna and utilize a two port integrated circuit (IC), one port connected to each antenna. The IC can cause the RFID tag to switch between the two antennas so that the RFID tag can operate in either of two different frequency bands, depending on the application in which the tag is being used. The IC also causes the RFID tag to operate according to either of two distinct state machines providing the required control logic to operate the tag in a mode corresponding to either of the antennas.

For example, an RFID tag can be constructed with a first single dipole antenna, resonant in the UHF band, and a second separate antenna, resonant in the 8.2 MHz band which is popular for electronic article surveillance (EAS) operations. Distinct input ports of the IC connect to each of these two separate and distinct antennas, respectively. RFID tag internal circuitry controls which antenna is activated. Such commands may be self-generated, manually provided, or received from an RFID reader with which the RFID tag interacts. Thus, a single RFID tag with two integrated antennas can be used in two distinct applications. For example, a single RFID tag could be used in both supply chain management and EAS applications which typically utilize different frequency bands. As industries evolve and transition from the use of one technology to another, such dual antenna RFID tag can be useful. For example, a dual mode RFID tag could be useful in transitioning from an EAS solution to an RFID solution in a retail environment.

In this description, numerous specific details are set forth in order to provide a thorough understanding of the present invention. However, it will become obvious to those skilled in the art that the present invention may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

Embodiments of the inventions are discussed herein with reference to the various figures. However, those skilled in the art to which these inventions pertain will readily appreciate that the detailed description given herein with respect to these figures is for explanatory purposes as the inventions extend beyond these limited embodiments.

FIG. 3a is a schematic diagram illustrating a concept of the invention. An RFID tag 102 has two integrated antennas 350 and 352. An integrated switch 354 is capable of connecting either antenna 350 or antenna 352 to a front end 354 of the RFID tag. In an embodiment, antennas 350 and 352 are connected to two ports of the IC. Switch 354 is integrated into the IC and switching occurs internal to the IC. As an alternative, separate switch elements can be provided to perform the function of switch 354. In a single antenna RFID tag, the tag's IC configures itself to operate at least in part as a state machine which causes the tag to operate according to predetermined steps to carry out its functions. In a dual antenna RFID tag, IC 356 operates as either of two state machines, namely STATE MACHINE 1 designated by reference numeral 358 or STATE MACHINE 2 designated by reference numeral 360. For RFID tags capable of operating in three or more modes with three or more antennas, IC 356 would be able to configure itself as three or more state machines, as necessary. With IC 356 operating as STATE MACHINE 1, and using antenna 350, RFID tag 102 operates according to a first mode. When the RFID tag 102 changes its mode of operation to a second mode, it utilizes antenna 352 and IC 356 configures the RFID tag to operate as STATE MACHINE 2.

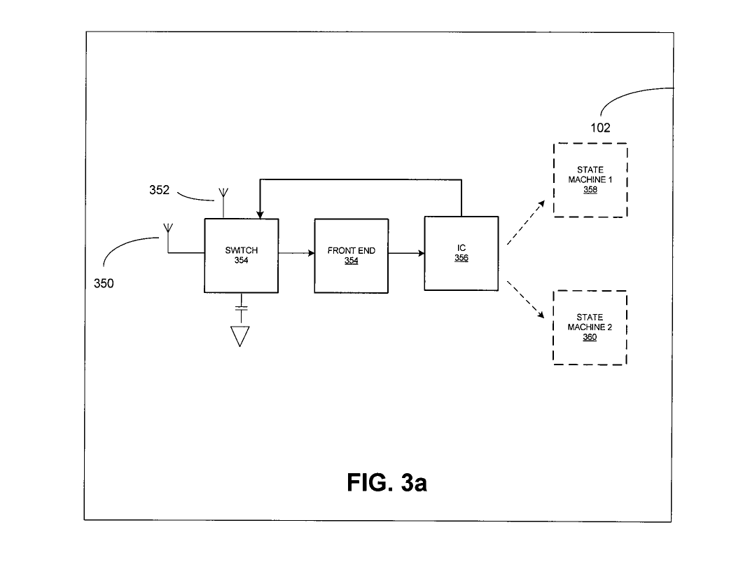

FIG. 4 is a schematic diagram of an RFID tag having first and second integrated dipole antennas and an RFID integrated circuit (IC) having separate ports to which the first and second antennas are coupled. An RFID tag 102 includes an RFID integrated circuit (RFID IC) 420 having first and second ports 430, 432. A first integrated dipole antenna 440 connects to port 430 and a second integrated dipole antenna 442 connects to port 432.

Antenna patterns for antennas 440 and 442 are imprinted onto a flexible substrate such as, for example, made of a mylar material, by printing conductive material such as silver ink, chemically etching a substrate plated with conductive materials such as copper, or stamping the antenna pattern onto a plated substrate. For some antenna configurations, an antenna pattern my require an impedance matching or loading network. If a coil is required, such as for use with 8.2 MHz EAS, coil terminals 444,446 are connected to each port by means of a stamped via hole through the substrate material. UHF antenna elements typically have quarter wavelength resonant elements while coils require the necessary aperture and turns to collect sufficient magnetic energy to activate the IC on the tag.

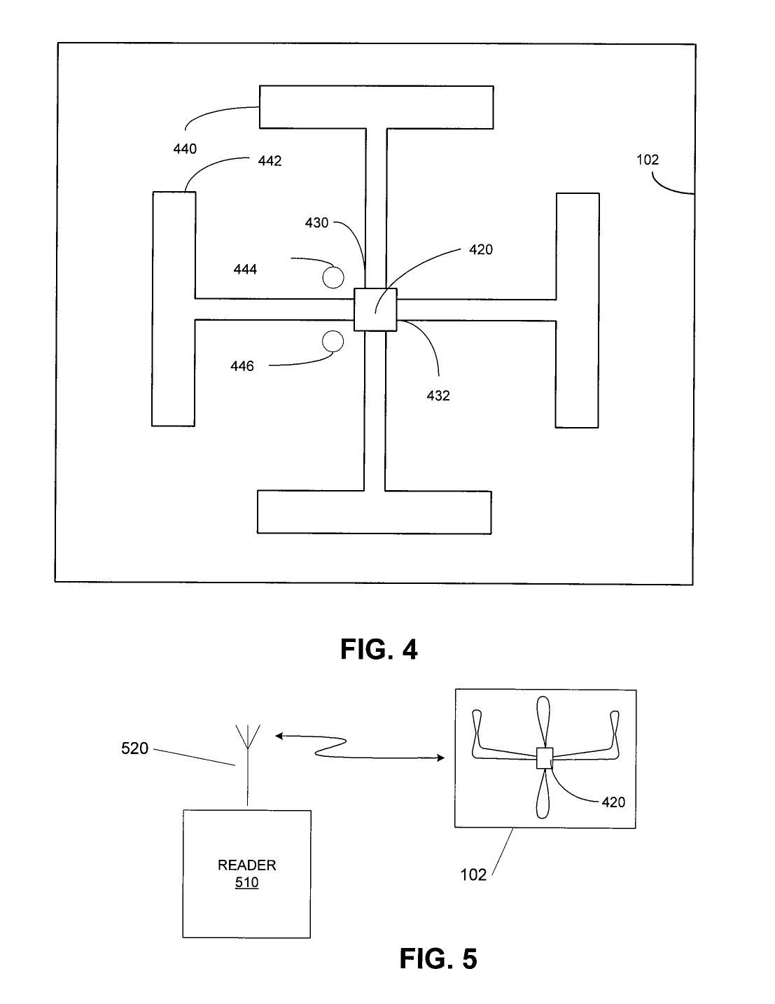

FIG. 5 is a schematic diagram of an RFID reader interacting with an RFID tag having dual integrated antennas. An RFID reader 510 communicates through an antenna 520 with one or more RFID tag 102 via either of the tag's antennas, for example antennas 440 and 442 shown in the FIG. 4 embodiment. During such communication RFID reader 510 can send a command to RFID IC 420 to cause it to change its mode of operation and make a live connection to either port 430 or 432 (see FIG. 4).

As an example, a reader can communicate to the UHF portion of the tag circuit with a recognized air interface protocol such as EPC gen-2. A unique command could be delivered to the reader requesting the tag IC operate its state machine for 13.56 MHz and ISO 14443 protocol. In such a case, a 13.56 MHz coil attached to the IC is electrically connected to the analog demodulation components with thin the IC to de-modulate the bit stream from the 13.56 MHz carrier. The IC state machine is configured to decode the bit stream in compliance with the ISO 14443 standard. In this way, a long range UHF reader can command the tag to change its physical and operating characteristics entirely; preparing the tag for use in a totally different application (in this case near contact, higher security reading) from its initial state (in this case, long range reading for vehicle access control applications).

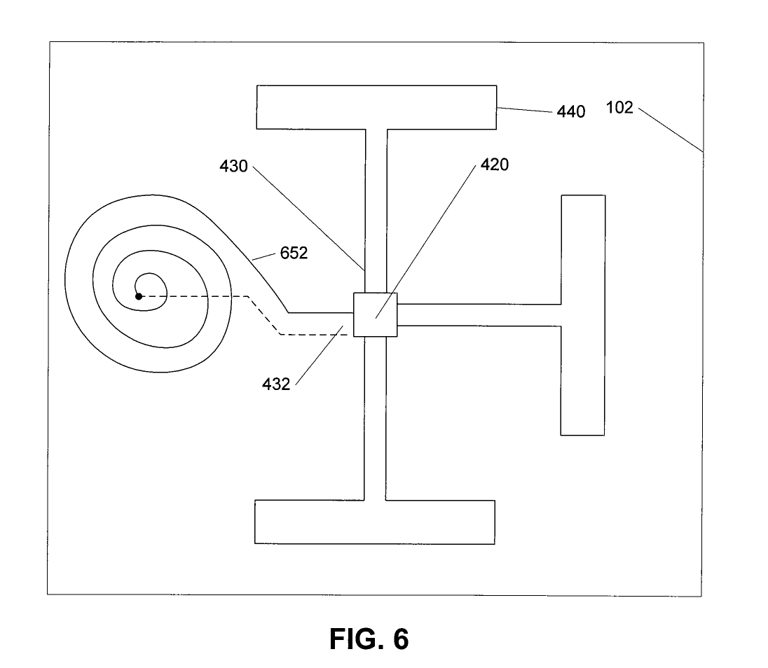

FIG. 6 is a schematic diagram of an RFID tag having first and second integrated antennas and an RFID integrated circuit (IC) having separate ports to which the first and second antennas are coupled. This embodiment is similar to the RFID tag embodiment shown in FIG. 4, except that dipole antenna 442 has been replaced by a spiral antenna 652 connected to port 432 of RFID integrated circuit (RFID IC) 420.

A spiral antenna is typically formed by etching or stamping a metallization layer on the substrate to form a magnetic antenna topology. To complete the coil circuit, the terminals of the coil must be connected to a port on the tag IC. This poses some problems in tag construction as the terminals must not short circuit the various turns of the coil in its path to connect to the IC ports. This problem is solved by staking the terminal through the substrate layer and then connecting the terminal through the other side of the substrate. The amount of magnetic energy from the reader coupled to the coil is dependent on coil aperture and number of coil turns. Reading range is reliant on coupling the maximum amount of magnetic energy from the reader.

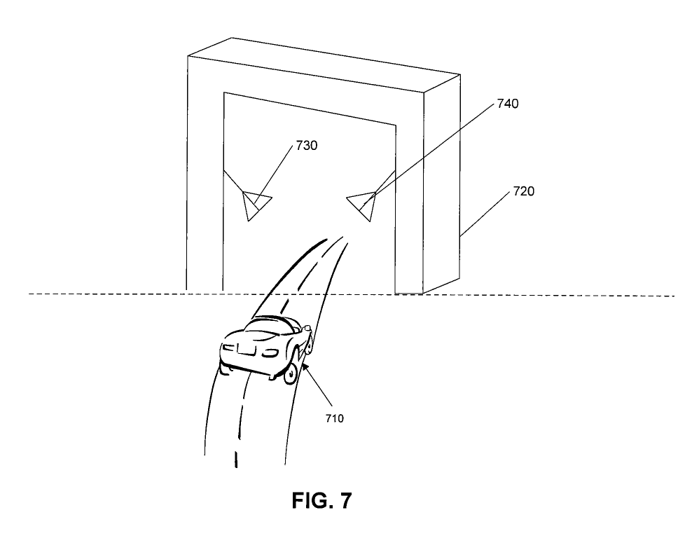

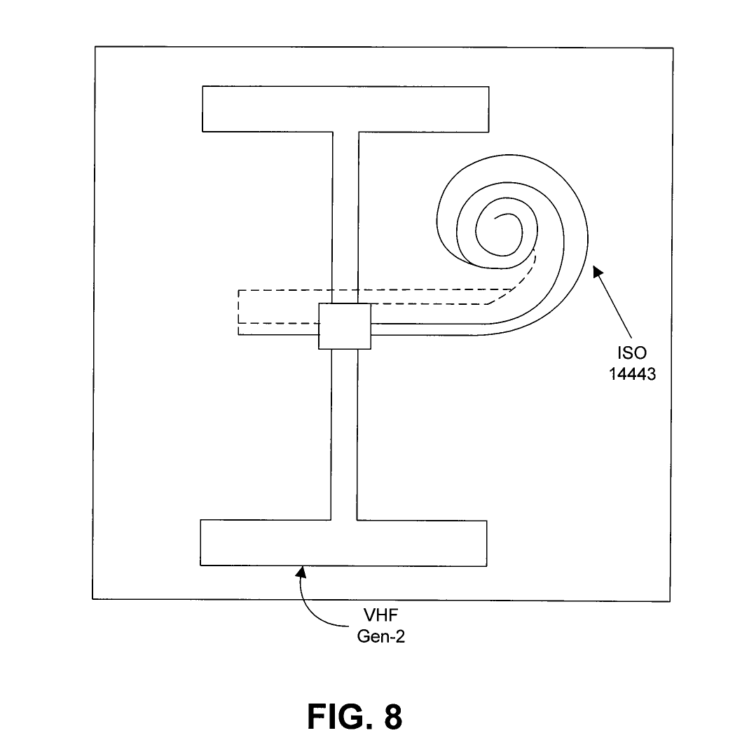

FIG. 7 is a schematic diagram of an RFID system arrangement in which one of the modes of operation is a long range mode. A long range mode is suitable for example for vehicle access control at a border crossing. The same RFID system can operate in a second mode such as a shorter range more secure protocol such as ISO 14443 for contactless reading at passport control. A traveler 710 passes through a barrier 720 at a border crossing. Two antennas 730 and 740 associated with an RFID reader send signals to and RFID tag (not shown) associated with traveler 710. The use of a dual mode tag and dual mode RFID reader allows the longer range application suitable for such a border crossing and can be switched to a shorter range application such as for passport control. An RFID tag embodiment suitable for use by traveler 710 is shown in FIG. 8.

FIG. 8 is a schematic diagram of a dual mode RFID tag including a dipole antenna operating in the VHF band and a spiral antenna operating on the ISO 14443 standard. The dipole antenna is suitable for the long range operation at VHF while the spiral antenna is suitable for the shorter range more secure protocol such as ISO 14443 for contactless reading at passport control.

In addition to the RFID tag being configured to switch between two different antenna topologies, the RFID tag IC is configured so that it can operate as two distinct state machines, to operate the RFID tag with the characteristics appropriate to satisfy the requirements of different applications. The tag antenna (topology) drives the physical characteristics of the RFID tag, and the state machine changes the operating characteristics. This RFID tag configuration, as with the other exemplary embodiments utilizes a multiport IC that can be operated as any of at least two state machines.

The invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

### Alternatives

Those skilled in the RFID arts will recognize that alternatives to the exemplary embodiments and configurations described are possible. For example, the 2 ports of the IC could serve as a switch, to add capacitive elements to the EAS antenna, making it resonant at 8.2 MHz for EAS, or to activate the UHF antenna element for reading at dock doors, retail shelf, or other reading points of the supply chain application.

In an alternative embodiment, there is provided an RFID tag that is factory set for UHF operation, until the retail item is purchased at the point of sale (POS). The UHF system, at the receiving dock door or at the transition point between the store, having read the tag using UHF, sends a command to the tag switching it to 8.2 MHz mode, which is then read by the existing EAS portals at the store exit without having to modify those exit portal for REID reading.

### CONCLUSION

The above examples are specific exemplary embodiments of dual mode RFID tag arrangements. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A dual mode RFID tag, comprising:
a dual mode integrated circuit including at least dual antenna input ports;
a first antenna coupled to a first of the at least dual antenna input ports;
a second antenna coupled to a second of the at least dual antenna input ports; and
a switch means for causing the integrated circuit to connect to make active either the first or second antenna port.

2. A dual mode RFID tag according to claim A1 wherein the switch means is configured so as to be responsive to an externally generated and received signal.

3. A dual mode RFID tag according to claim A1 wherein the first and second antennas are integrated dipole antennas tuned to different frequency bands.

4. A dual mode RFID tag according to claim A4 wherein the first antenna is tuned to operate in the UHF band and the second antenna is tuned to operate in the 8.2 MHz band.

5. A dual mode RFID tag according to claim A1 further comprising a capacitive element and wherein the integrated circuit, when switching from a first mode of operation to a second mode of operation causes the capacitive element to be connected to one of the antennas.

6. A dual mode RFID tag according to claim A4 wherein the first antenna is tuned to operate in the VHF band and the second antenna is constructed and arranged to operate in a mode consistent with the ISO 14443 standard.

7. A dual mode RFID tag according to claim A1 further comprising an integrated circuit (IC) constructed and arranged to operate the RFID tag as either a first or second state machine, one state machine corresponding to each of the antennas.

8. A dual mode RFID tag, comprising:
a dual mode integrated circuit operable in a first UHF mode and a second EAS mode and including two antenna input ports;
a UHF antenna coupled to a first of the two antenna input ports;
a EAS mode antenna coupled to a second of the two antenna input ports; and
control logic for causing the integrated circuit to operate selectively in either the UHF or EAS mode; and
a switch for connecting causing either of the antennas to be actively connected to the IC when the IC is operated in its corresponding mode.

9. A method for operating an RFID tag, comprising:
receiving signals from a first RFID tag antenna;
operating a dual mode integrated circuit (IC) of the RFID tag as a first state machine while receiving signals from a first RFID tag antenna;
receiving signals from a second RFID tag antenna;
operating a dual mode integrated circuit (IC) of the RFID tag as a second state machine while receiving signals from a second RFID tag antenna;

10. A method according to claim C1 further comprising:
receiving an external signal; and
changing from first state machine operation to second state machine operation in response thereto.

11. A method according to claim C2 further comprising:
receiving an external signal; and
changing from second state machine operation to first state machine operation in response thereto.
